(19) United States
(12) Patent Application Publication
(10) Pub. No.: US 2017/0089043 A1
(43) Pub. Date: Mar. 30, 2017

(54) ONLINE SYSTEM IDENTIFICATION FOR CONTROLLING A MACHINE

(71) Applicant: Caterpillar Inc., Peoria, IL (US)

(72) Inventors: Insu CHANG, Peoria, IL (US); Salim Aziz JALIWALA, Peoria, IL (US); James Sheridan CHASE, Chillicothe, IL (US)

(73) Assignee: CATERPILLAR INC., Peoria, IL (US)

(21) Appl. No.: 14/865,864

(22) Filed: Sep. 25, 2015

(51) Int. Cl. E02F 9/26; E02F 9/20; E02F 3/43; G05B 15/02

(52) U.S. Cl. CPC E02F 9/264; G05B 15/02; E02F 9/2025; E02F 3/435

(57) ABSTRACT

A control system for a machine may include an electronic controller configured to receive a sensor signal indicative of an operational parameter of the machine, and to output a control signal to an actuator to control an operational characteristic of the machine. The electronic controller may include a poles-zeros identification module, an onboard system identification module configured for online, real-time identification of one or more transfer functions that govern a dynamic relationship between one or more inputs and one or more outputs of at least one plant model, wherein the at least one plant model is representative of behaviors of the machine and simulates a dynamic influence of the operational parameter, and a comparator that determines the accuracy of a plant model.

### TECHNICAL FIELD

This disclosure relates generally to a control system for a machine and, more particularly, to online system identification for automatically identifying a plant model used by the control system in controlling the machine.

### BACKGROUND

Computer-based control methodologies may be used in many industries to facilitate efficient and accurate control of complex systems. These control methodologies often use various algorithms or models to simulate operation of complex systems such as heavy machinery, internal combustion engines, communication networks, buildings, airplanes, power plants, etc. For example, a model for a machine control system may provide correlations between various manual and automated inputs and the resulting outputs that determine operations and behaviors of engines and generators that power the machine, movement of work tools such as the bucket on a front end loader and the blade on a bulldozer, and the overall movement of a mobile machine. The system to be controlled is generally referred to as the “plant”. Computationally intense simulations are required to evaluate the accuracy of these plant models for the control system. A more accurate plant model for the control system reduces errors or differences between actual responses of the plant to control signals received from the control system and predicted responses of the plant, which is the output of the plant model.

Various machines are often controlled using onboard electronic controllers. Example machines include earth moving machines such as tractors, front end loaders, dump trucks, excavators, and mining machinery. Among other operations, the onboard electronic controllers typically manage the use of engines, generators, solenoid valves, motors, pumps, and other equipment onboard the machine. The electronic controllers could, for example, initiate production of control signals that are provided to the various equipment onboard the machine, monitor the resulting operation of the equipment, and generate alarms when malfunctions are detected. One example of a conventional controller is the Proportional-Integral-Derivative (PID) controller, which is very common in industrial control systems. These types of controllers are often “tuned” or adjusted during operation, which involves altering parameters of the controllers to ensure more reliable or accurate operations. Conventional controllers also typically operate using plant models that are derived offline using commercial software such as the graphical programming environment SIMULINK® integrated within the software MATLAB® developed by Mathworks. The models allow the controllers to determine, based on input signals from sensors or other data, how to control the equipment. For long-term and successful control of the machinery, it is often necessary to perform “system identification” in order to generate and update an accurate model of the plant being controlled.

The various controller plant models may be derived by using a large number of data sets of operating parameters and design parameters that correlate to corresponding output signals. Optimization methods may be used to find optimum plant models that provide accurate predictions of output signals. The optimization of plant models may be carried out by various techniques and may often involve many iterations of simulations. System identification, or the derivation of a plant model that will provide an accurate relationship between inputs to the plant and calculated output parameters corresponding to actual output parameters for the plant can take a long time and utilize a large amount of computing resources. For example, U.S. Pat. No. 8,321,183 issued to Shah et al. on Nov. 27, 2012 (the '183 patent), discloses a computer-implemented method of designing a system to achieve a target goal. The method disclosed in the '183 patent creates an inventory of a plurality of variables that affect the design of the system. The inventory includes a feasibility range for each of the plurality of variables contained in the inventory. Initial values are assigned for the plurality of variables and a model of input to output correlations of the variables is created. The processor then attempts to achieve a goal for the system by manipulating the variables in a particular order based on the respective levels of effects.

While the method disclosed in the '183 patent may assist a product designer in determining modifications that should be made to various input variables to achieve system goals, there is still room for improvement. For example, the techniques disclosed in the '183 patent may depend on having already identified a particular plant model that establishes the correlation between input signals and associated responses of the system. Identification of a plant model, or system identification, is a critical step in the design of an optimum control system for the plant. However, system identification takes a long time and consumes a large amount of computing resources. As discussed above, the preliminary identification of an acceptable plant model is therefore generally performed offboard the machine or system using commercially available software that consumes a large amount of time and computing resources. Therefore, a system identification tool that can provide accurate estimates of new plant models onboard a machine with significantly less computation required, and update existing plant models automatically and in real time would save significant amounts of time and money in the development of control systems.

Methods and systems consistent with certain features of the disclosed systems are directed to solving one or more of the problems set forth above or other problems in the prior art.

### SUMMARY

One aspect of the present disclosure includes a control system for a machine. The control system may include one or more sensors and actuators configured to measure and control operational characteristics of the machine, and an electronic controller mounted onboard the machine. The electronic controller may be configured to receive a sensor signal indicative of an operational parameter of the machine, and to output a control signal to an actuator to control an operational characteristic of the machine. The electronic controller may include a poles-zeros identification module configured for determining poles of one or more transfer functions as roots of the denominator of the one or more transfer functions and determining zeros of the one or more transfer functions as roots of the numerator of the one or more transfer functions. The electronic controller may also include an onboard system identification module configured for online, real-time identification of the one or more transfer functions that govern a dynamic relationship between one or more inputs and one or more outputs of at least one plant model. The at least one plant model may be representative of behaviors of the machine and may simulate a dynamic influence of the operational parameter on a desired output of the machine. The onboard system identification module may be further configured to define an order of a numerator of the one or more transfer functions and an order of a denominator of the one or more transfer functions based on a complexity of the dynamic relationship between the one or more inputs and the one or more outputs. The electronic controller may further include a testing module configured for generating a reference signal and supplying the reference signal as an input to the one or more transfer functions, and a comparator configured for determining an accuracy of the at least one plant model by determining an error between a measured response of the machine to the reference signal and a predicted response obtained from the one or more transfer functions with the poles and zeros.

Another aspect of the present disclosure includes a method of controlling a machine. The method may include measuring an operational parameter characterizing operation of the machine using a sensor, receiving at an onboard electronic controller a sensor signal from the sensor indicative of the operational parameter of the machine, and outputting a control signal from the onboard electronic controller to an actuator to control an operational characteristic of the machine. The method may also include determining poles of one or more transfer functions as roots of the denominator of the one or more transfer functions and determining zeros of the one or more transfer functions as roots of the numerator of the one or more transfer functions, identifying in real-time one or more transfer functions using a system identification module that is included in the onboard electronic controller, wherein the one or more transfer functions govern a dynamic relationship between one or more inputs and one or more outputs of at least one plant model, and wherein the at least one plant model is representative of behaviors of the machine and simulates a dynamic influence of the operational parameter on a desired output of the machine. The method may further include defining an order of the one or more transfer functions based on a complexity of the dynamic relationship between the one or more inputs and the one or more outputs, generating a reference signal and supplying the reference signal as an input to the one or more transfer functions, and determining an accuracy of the at least one plant model by determining an error between a measured response of the machine to the reference signal and a predicted response calculated from locations of the poles and zeros of the one or more transfer functions.

Another aspect of the present disclosure includes a computer-readable medium for use in a machine control system, the computer-readable medium comprising computer-executable instructions for performing a method with at least one processor of an onboard electronic controller of a machine. The method may include receiving at the onboard electronic controller a sensor signal from a sensor indicative of an operational parameter of the machine, and outputting a control signal from the onboard electronic controller to an actuator to control an operational characteristic of the machine. The method may also include determining poles of one or more transfer functions as roots of the denominator of the one or more transfer functions and determining zeros of the one or more transfer functions as roots of the numerator of the one or more transfer functions, identifying in real-time the one or more transfer functions using a system identification module that is included in the onboard electronic controller, wherein the one or more transfer functions govern a dynamic relationship between one or more inputs and one or more outputs of at least one plant model, and wherein the at least one plant model is representative of behaviors of the machine and simulates a dynamic influence of the operational parameter on a desired output of the machine. The method may further include defining an order of the one or more transfer functions based on a complexity of the dynamic relationship between the one or more inputs and the one or more outputs. The method may still further include generating a reference signal and supplying the reference signal as an input to the one or more transfer functions, and determining an accuracy of the at least one plant model by determining an error between a measured response of the machine to the reference signal and a predicted response calculated from locations of the poles and zeros of the one or more transfer functions.

### BRIEF DESCRIPTION OF THE DRAWINGS

FIG. 1 illustrates an exemplary machine that may include a control system according to aspects of this disclosure;

FIG. 2 illustrates a block diagram of a computer-implemented control system that may be used with the exemplary machine shown in FIG. 1;

FIG. 3 illustrates a system identification flowchart in accordance with an exemplary implementation of this disclosure;

FIG. 4 illustrates a detailed flowchart for a portion of the flowchart shown in FIG. 3;

FIG. 5 illustrates a detailed flowchart for a portion of the flowchart shown in FIG. 4; and

FIG. 6 illustrates a detailed flowchart for a portion of the flowchart shown in FIG. 5.

### DETAILED DESCRIPTION

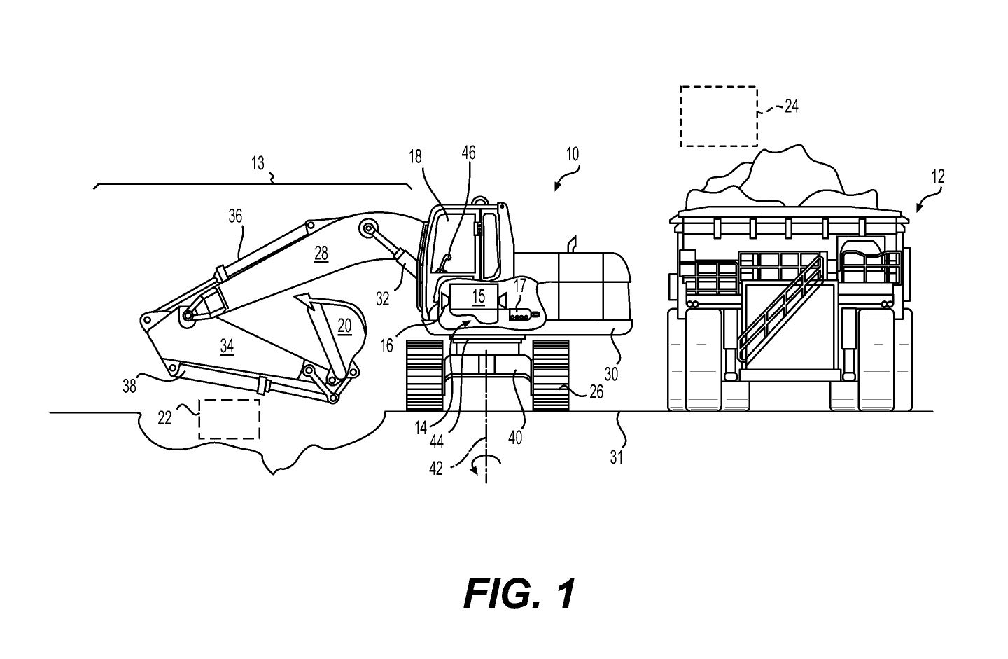

FIG. 1 illustrates an exemplary machine 10 that may include a control system and online system identification features for determining accurate plant models to be used by the control system in controlling operations of the machine 10 in accordance with various embodiments of this disclosure. Although a hydraulic excavator is shown, the control system and online system identification features described in this disclosure may be employed on any machine where an accurate method of predicting and controlling behaviors of the machine is desired. The machine 10 may have multiple systems and components that cooperate to excavate and load earthen material onto a nearby haul vehicle 12. The machine 10 may embody another type of machine such as a backhoe, a front shovel, a wheel loader, or another machine. The machine 10 may include, among other things, an implement system 13, a powertrain 14, and an operator station 18 for manual control of the implement system 13 and the powertrain 14. The implement system 13 may be driven by the powertrain 14 to repetitively move a work tool 20 between a dig location 22 within a trench and a dump location 24 over the haul vehicle 12 during completion of a particular work cycle. However, the implement system 13 may be configured to move the work tool 20 in another manner during a different work cycle, if desired. The powertrain 14, in addition to driving the implement system 13, may also function to propel the machine 10, for example via one or more traction devices 26.

As shown in FIG. 1, the disclosed implement system 13 may include a linkage structure that cooperates with fluid actuators to move the work tool 20. Specifically, the implement system 13 may include a boom 28 that is pivotally connected to a frame 30 of the machine 10 and vertically movable by a pair of hydraulic cylinders 32 (only one shown in FIG. 1). The implement system 13 may also include a stick 34 that is pivotally connected between the boom 28 and the work tool 20, and movable by a single hydraulic cylinder 36. The implement system 13 may further include a single hydraulic cylinder 38 operatively connected to vertically pivot the work tool 20 relative to the stick 34. The frame 30 may be connected to an undercarriage member 40, and swung (together with the boom 28, the stick 34, and the work tool 20) about a vertical axis 42 by a swing motor 44. A greater or lesser number of fluid actuators may be included within the implement system 13 and/or connected in a manner other than described above, if desired. Although fluid actuators are shown in FIG. 1 for manipulating the implement system 13, it will be appreciated that the implement system 13 may include other types of actuators known in the art, such as electric motors, for example.

The powertrain 14 may include, among other things, an engine 15 and a transmission 17. The engine 15 may be secured to the frame 30 via a mounting system 16, and may be configured to produce a rotational power output. The transmission 17 may then convert the power output to a desired ratio of speed and torque. The rotational power output may be used to drive a pump that supplies pressurized fluid to the cylinders 32, 36, and 38; to the swing motor 44; and/or to one or more motors (not shown) associated with the traction devices 26. In some embodiments, the rotational power output of the engine 15 may additionally be directed to drive a generator that produces electricity used to control the machine 10. The engine 15 may be a combustion engine configured to burn a mixture of fuel and air, the amount and/or composition of which directly corresponding to the rotational power output. The transmission 17 of the powertrain 14 may take any form known in the art, for example a power shift configuration that provides multiple discrete operating ranges, a continuously variable configuration, or a hybrid configuration.

The operator station 18 may include a cabin for housing one or more operator interface devices 46 located proximate an operator seat (not shown). The interface devices 46 may be embodied as joysticks, pedals, switches, wheels, knobs, and/or any other device known in the art. The interface device 46 may be configured to generate signals that are used to control the machine 10. For example, the interface device 46 may be a joystick that, when displaced from a neutral position, creates a signal indicative of a desired machine or tool speed or force in a particular direction. This signal may be then be used to actuate any one or more of the hydraulic cylinders 32, 36, 38; the swing motor 44; and/or the traction motors discussed above.

Numerous different work tools 20 may be attachable to a single machine 10 and controllable via the operator station 18. The work tool 20 may include any device used to perform a particular task such as, for example, a bucket, a fork arrangement, a blade, a shovel, a truck bed, or any other task-performing device known in the art. Although connected in the embodiment of FIG. 1 to pivot relative to the machine 10, the work tool 20 may alternatively or additionally rotate, slide, swing, lift, or move in any other manner known in the art.

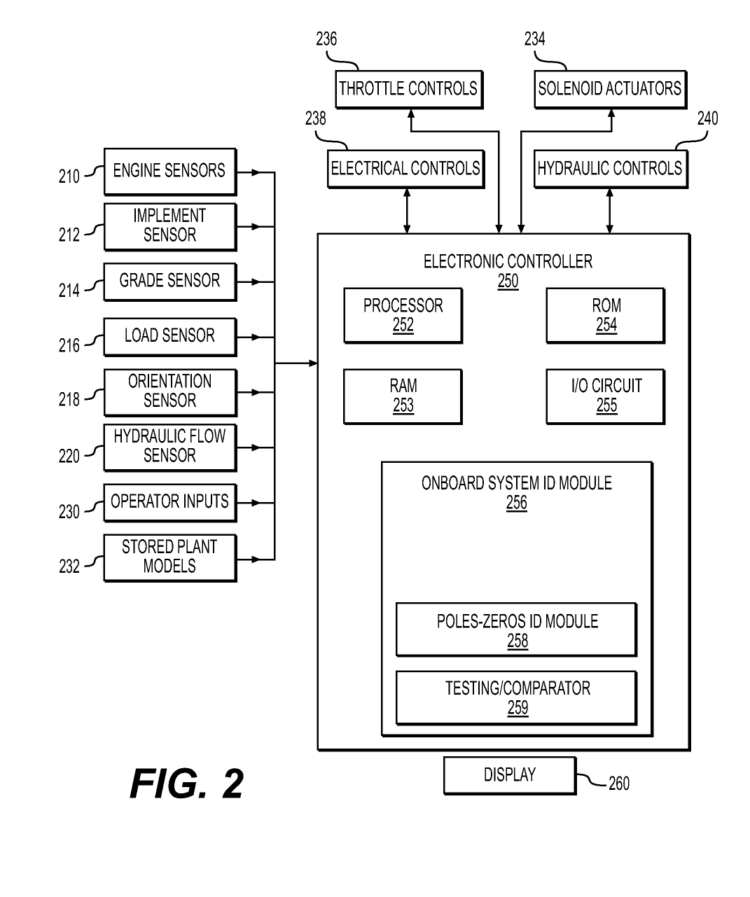

As illustrated in FIG. 2, the machine 10 may further include a control system configured to monitor and perform operations of the machine 10 in order to achieve various tasks. In particular, the control system may include a plurality of sensors such as an engine sensor 210, an implement sensor 212, a grade sensor 214, a load sensor 216, an orientation sensor 218, and a hydraulic flow sensor 220. The control system may also include operator inputs 230 and a database of stored plant models 232. The control system may further include actuators and controls such as solenoid actuators 234, throttle controls 236, electrical controls 238, and hydraulic controls 240. An onboard electronic controller 250 may be communicatively coupled with the sensors, actuators, and controls via one or more wired and/or wireless interfaces. The onboard electronic controller 250 may include one or more processors 252, Random-Access-Memory (RAM) 253, Read-Only-Memory (ROM) 254, Input/Output (I/O) circuitry 255, an onboard system identification module 256, a poles-zeros identification module 258, and a testing and comparator module 259. The electronic controller 250 may also be configured to output the results from determination of an optimal plant model by the system identification module 256 to a user interface (display) 260. The user interface may provide a means for an operator to select a preferred plant model for use by the electronic controller, and/or to request an immediate, online update or improvement to a plant model having a higher accuracy than a currently selected plant model.

The exemplary control system illustrated in FIG. 2 may include the one or more sensors and actuators described above and configured to measure and control operational characteristics of the machine. For example, the engine sensors 210 may have one or more components configured to generate a signal indicative of an actual speed of a power output component. An engine sensor 210 may have a component associated with a crankshaft (not shown) of the powertrain 14 and/or with a transmission input or output shaft. The engine sensor 210 may include a permanent magnet embedded in any of these rotating shafts, and a stationary sensing element (e.g., a hall-effect element) spaced near the component and configured to detect a rotating field produced by the magnet. Signals generated by the sensing element of the engine sensor 210 may be directed to the onboard electronic controller 250 for further processing.

The implement sensor 212 may be configured to generate a signal indicative of the presence of a particular work tool 20 mounted on the stick 34. This information may be provided by a Radio Frequency Identification (RFID) device mounted on the work tool 20. The implement sensor 212 may also be configured to generate a signal indicative of an exact position of an edge of a work tool such as the work tool 20 shown in FIG. 1. The position information may be derived by reference to a GPS signal, a proximity sensor, or other means.

The grade sensor 214 may be configured to determine a grade of a work surface 31 under the machine 10. For example, the grade sensor 56 may be configured to generate a signal indicative of a position and/or orientation of a particular point on the machine 10 (e.g., of an intermediate point on an associated front or rear axle). The position/orientation may then be used to calculate an overall pitch of the machine 10 in a travel direction, and a corresponding grade of the work surface 31 under the machine 10. In an alternative embodiment, the grade sensor 214 may be an Inertial Measurement Unit (IMU) having one or more accelerometers and/or gyroscopes that generate signals indicative of the change in machine orientation relative to the force of gravity. Other types of sensors may alternatively be used to determine the grade of the work surface 31. Signals generated by the grade sensor 214 may be directed to the onboard electronic controller 250 for further processing.

The load sensor 216 may be configured to generate a signal indicative of a load carried by, moved by, or otherwise bearing on the machine 10. In one example, the load sensor 216 may be a pressure sensor associated with any one or more of the cylinders 32, 36, and 38, the signal from this sensor being used to calculate a load on the corresponding cylinder that can be related to the load carried by the work tool 20. In another example, the load sensor 216 may be a mechanical load cell strategically placed between mating mechanical components of the machine 10 (e.g., between linkage members) and/or on support structure of the implement system 13. The signal from this load sensor 216 may be related to strain of the components and used to calculate the load on the work tool 20. The signals from the load sensor 216 may be directed to the electronic controller 250 for further processing.

Additional sensors such as the orientation sensor 218 and hydraulic flow sensor 220 may provide inputs to the electronic controller 250. In addition to these automatically provided inputs from various sensors, operator manual inputs 230 such as movements of a joystick, lever, or other input device, may be provided to the electronic controller 250. Additionally, stored plant models 232 may be retrieved from memory onboard the machine or from one or more databases offboard the machine and in wireless communication with the electronic controller 250. The stored plant models 232 may be representative of known behaviors of a particular machine under various circumstances, and may be used to simulate a dynamic influence of various operational parameters on movement of the work tool 20 or other outputs of the machine 10.

The electronic controller 250 mounted onboard the machine 10 may be configured to receive a sensor signal indicative of an operational parameter of the machine, and to output a control signal to an actuator to control an operational characteristic of the machine. Some examples of actuators that control operational characteristics of the machine are illustrated in FIG. 2, and include the solenoid actuators 234, the throttle controls 236, the electrical controls 238, and the hydraulic controls 240. The electronic controller 250 may include the onboard system identification module 256 configured for online, real-time identification of one or more transfer functions that govern a dynamic relationship between inputs and outputs of at least one plant model. The at least one plant model may be representative of behaviors of the machine 10 and may simulate a dynamic influence of one or more operational parameters measured by the sensors described above. The transfer functions are mathematical representations of the dynamic relationship between the inputs and outputs based on differential equations describing the system. The electronic controller 250 may also measure a rise time for the control system that is a function of the time needed by the control system to reach a desired output value after a change in an input to the control system, and a DC gain for the control system.

The onboard system identification module 256 may be further configured to define an order of a numerator of a transfer function and an order of a denominator of a transfer function based on a complexity of the dynamic relationship between the inputs to the machine and the outputs of the machine. Higher order polynomial equations may be required in the numerator and denominator of each transfer function to provide an accurate representation of the correlation between inputs and outputs for the machine when a large number of factors influence an output such as movement of a work tool. Some exemplary factors that may increase the complexity of the dynamic relationship may include complexity of the machine structure such as the numbers of hydraulic components activated to move a work tool, wear and tear on various components of the machine, the age of the machine, external environmental conditions, etc.

The poles-zeros identification module 258 included in the onboard system ID module 256 in the electronic controller 250 may be configured for determining poles of each transfer function as roots of the denominator of the transfer function and determining zeros of each transfer function as roots of the numerator of the transfer function. Providing a transfer function in factored form may allow the onboard electronic controller 250 to quickly determine and/or update an optimal plant model for use in controlling the machine in real time without requiring any offboard computing resources. Location of the poles and zeros for a transfer function requires considerably less calculation and computing resources than derivation of the coefficients of the polynomials of a transfer function in normal form. The search space for determining the poles and zeros is directly related to the location of each pole and zero, and therefore the order of the transfer function selected to represent the dynamic relationship between inputs and outputs for the machine does not affect the size of the search space.

The automatic process performed by the onboard system identification module 256 mainly with the poles-zeros identification module 258 can be done much faster and with higher accuracy than standard, offline approaches to system identification. The electronic controller 250 in accordance with various exemplary implementations of this disclosure uses a direct pole-zero approach to find a plant model that provides the best representation of the correlation between machine inputs and outputs. The direct pole-zero approach simplifies optimization of system identification over the conventional direct coefficient search-based approach performed offline by commercial software. As an example, it may be assumed that a plant model for a machine to be identified can be represented by a 5th order differential equation. After several iterations, system identification tools may determine that the machine or plant has a 5th order model with the following form:

$$G ( s ) = \frac{{b}_{0} {s}^{4} + {b}_{1} {s}^{3} + {b}_{2} {s}^{2} + {b}_{3} s + {b}_{4}}{{s}^{5} + {a}_{1} {s}^{4} + {a}_{2} {s}^{3} + {a}_{3} {s}^{2} + {a}_{4} s + {a}_{5}}$$

where the coefficients of the polynomials in the numerator and denominator of the transfer function (aⱼ (j=1, 2, 3, 4, 5) and bₖ (k=0, 1, 2, 3, 4)) are parameters to be estimated by using the system identification tools. Conventional methods of system identification try to find the coefficients of the polynomials aⱼ (j=1, 2, 3, 4, 5) and bₖ (k=0, 1, 2, 3, 4) directly. However, the size of the search spaces for each parameter can vary widely as a function of the order of the numerator and denominator of the transfer function, and may not be easily determined from or related to observed motion or other outputs of the machine. It is likely that as the number in the subscripts for the coefficients of the polynomials increases with higher order transfer functions, the search spaces required to identify the coefficients also increase. As an example, a₁ may be found between 0 and 10, while a₅ may require a search space between 0 and 10000. Therefore, when expressing a transfer function in standard form with polynomials in the numerator and the denominator having sufficiently high order to provide an accurate representation of the motion of the machine, the search spaces for determination of the coefficients of the polynomials may become very large.

However, when the transfer function is presented in factored form by the poles-zeros identification module 258, predictions of the locations of the poles and zeros of the unknown plant model may be determined from the movement or other outputs of the machine, and the required search spaces for determining the poles and the zeros of the transfer function are considerably smaller than the search spaces required for finding the coefficients of the polynomials of a transfer function in standard form. The transfer function of the 5th order plant model may be written in factored form by the determination of the number of poles and zeros:

$$G ( s ) = \frac{{b}_{0} ( s - {c}_{1} ) ( s - {s}_{2} ) ( s - {c}_{3} ) ( s - {c}_{4} )}{( s - {d}_{1} ) ( s - {d}_{2} ) ( s - {d}_{3} ) ( s - {d}_{4} ) ( s - {d}_{5} )}$$

where cⱼ (j=1, 2, 3, 4) and dₖ (k=1, 2, 3, 4, 5) are, respectively, zeros and poles of the transfer function G(s), which can be either pure real numbers, pure imaginary numbers, or complex numbers.

As shown in FIG. 2, a testing/comparator module 259 may also be included within the onboard electronic controller 250. The testing/comparator module 259 may be configured for generating a reference signal and supplying the reference signal as an input to the one or more transfer functions defined by the onboard system identification module 256. The comparator may be configured for determining an accuracy of a plant model defined by the transfer functions. The comparator may determine the accuracy of a plant model by calculating an error between an actual measured response of the machine to the reference signal and a predicted or calculated response. The predicted or calculated response for a plant model may be determined from the locations of the poles and zeros of the transfer function governing the dynamic relationship between inputs and outputs of the plant model, as determined by the poles-zeros identification module 258. The poles-zeros identification module 258 or other modules within the electronic controller 250 may be configured to perform various optimization techniques that may include one or more of particle swarm optimization (PSO), Monte Carlo simulations, and genetic algorithms, etc. The electronic controller 250 may be configured to perform iterations of calculations that include measuring the response of successive plant models to a reference signal such as pseudo-random-binary-sequence (PRBS) data, and determining the error between the actual response of the machine to the reference signal and the measured response. The optimization techniques may enable the electronic controller to quickly converge on local minimums defined as the local best locations of poles and zeros within subsets of possible ranges of poles and zeros. A local best location of poles and zeros may be determined when a successive iteration of a plant model having the identified poles and zeros no longer results in a smaller error than a previous iteration of a plant model. The electronic controller may be further configured to continue identifying successive iterations of plant models after having identified local minimums. Plant models characterized by transfer functions having poles and zeros located outside of the subsets considered in determining the local minimums may be further considered to obtain the global best locations of the poles and zeros. Various embodiments may limit continued iterations by defining a maximum number of possible iterations and/or a threshold level for the rate of propagation of additional poles and zeros.

The onboard electronic controller 250 may also be configured to communicate with a graphical user interface (display) 260 to present to a machine operator in real time at least one plant model identified by the onboard system identification module 256, and an associated accuracy of the at least one plant model as determined by the comparator. The user interface may be further configured to receive a selection by the machine operator of at least one of a preferred plant model or a request for identification of a plant model with an improved accuracy.

It should be noted that, while only a single processor 252 is shown in the electronic controller 250 of FIG. 2, any number of separate processors may collaborate to perform the functions of the control system for the machine 10. The electronic controller 250 may include a single module or multiple modules. Although the exemplary embodiment of FIG. 2 illustrates the poles-zeros identification module 258, and the testing/comparator module 259 as separate modules in the onboard system ID module 256, the functions performed by each of the illustrated modules may be performed by one or more modules, which may be contained in the same or separate modules. Numerous commercially available microprocessors may be configured to perform the functions of the different modules of the electronic controller 250. It should be appreciated that the electronic controller 250 could additionally be embodied in a general machine microprocessor capable of controlling numerous machine functions. Some or all of the modules of the electronic controller 250 may include a memory, a secondary storage device, a processor, and any other components for running an application. Various other circuits may be associated with the modules of the electronic controller 250, such as power supply circuitry, signal conditioning circuitry, solenoid driver circuitry, and other types of circuitry.

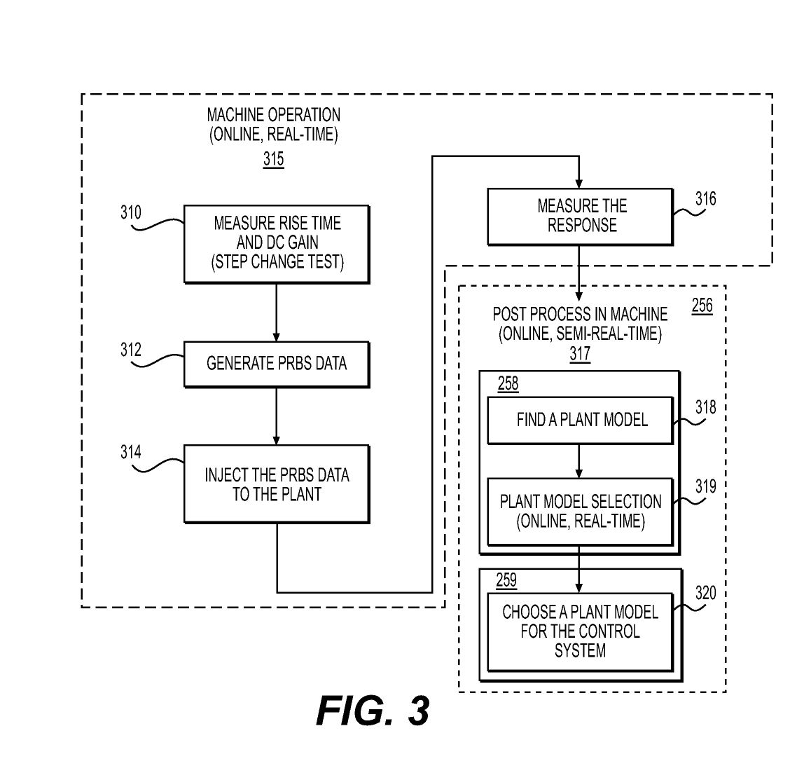

FIGS. 3-6 illustrate flowchart diagrams of an exemplary automatic online system identification method for determining an accurate plant model to be used in a control system for a machine. The details of the method summarized in these flowcharts will be described in detail in the following section.

### INDUSTRIAL APPLICABILITY

The disclosed systems and methods for controlling a machine may enable automatic, online, real-time identification of accurate plant models for use by a control system of the machine. Conventional system identification has required the collection of large amounts of data during the operation of a machine, transfer of the collected data offboard the machine for computer processing involving complex and time consuming commercial software to find a representative plant model, and then loading of the plant model back into the machine control system for use in controlling operations of the machine. Methods and systems in accordance with various implementations of this disclosure significantly streamline the process of developing accurate plant models for use in controlling machines. The exemplary disclosed implementations reduce the time and computing resources previously required for development and updating of plant models, thereby enabling an electronic controller onboard the machine to automatically identify accurate plant models online and in real time as operational circumstances change.

A method in accordance with various exemplary implementations of the disclosed system identification processes may include measuring an operational parameter characterizing operation of the machine using a sensor. An onboard electronic controller may receive a sensor signal indicative of the operational parameter of the machine, and output a control signal to an actuator to control an operational characteristic of the machine. The method may also include identifying in real-time one or more transfer functions using a system identification module that is included in the onboard electronic controller, wherein the one or more transfer functions govern a dynamic relationship between one or more inputs and one or more outputs of at least one plant model. The at least one plant model is representative of behaviors of the machine and simulates a dynamic influence of the operational parameter on a desired output of the machine.

The disclosed methods may further include defining an order of the one or more transfer functions based on a complexity of the dynamic relationship between the one or more inputs and the one or more outputs, and determining the one or more transfer functions. Poles of a transfer function may be determined as roots of the denominator of the one or more transfer functions, and zeros of the one or more transfer functions may be determined as roots of the numerator of the one or more transfer functions. The method may still further include generating a reference signal and supplying the reference signal as an input to the one or more transfer functions. A reference signal may comprise PRBS data. An accuracy of a plant model characterized by the one or more transfer functions may be calculated by determining an error between an actual response of the machine to the reference signal and a predicted response obtained from the transfer function with the poles and zeros.

Various implementations of the disclosed online system identification method may be performed by one or more processors included in the electronic controller 250 mounted on the machine 10. The one or more processors may also measure the rise time, or time it takes a control signal or command input to change from a specified low value to a high value. The control system of the machine may be configured to produce various control signals indicative of commands that are provided to various actuators, motors, pumps and other components that control motion and operation of the machine. The control signals may be determined by the one or more processors to achieve performance characteristics for the machine specified in terms of time-domain quantities, and in terms of transient and steady-state responses to a unit step input. A unit step signal may be used because of a close correlation between the control system's response to the unit step input and the control system's ability to perform under normal operating conditions.

As shown in FIG. 3, an exemplary online system identification method in accordance with this disclosure may include online, real-time machine operations illustrated in Box 315 and post process steps also performed in the machine online and in semi-real-time as illustrated in Box 317. At Step 310, the method may include measuring a rise time, or time it takes a control signal or command input to change from a specified low value to a high value. The method may also include determining a DC gain from the input signal (step change) and the measured response. The plant model is representative of the behavior of the machine 10 and simulates a dynamic influence of different operational parameters on a desired output of the machine 10. At Step 312, the method may include generating pseudo-random-binary-sequence (PRBS) data that is then injected at Step 314 into the plant. At Step 316 the response of the machine 10 to the PRBS data is measured. In one example, PRBS data may be an electrical input to a servo-motor or to an electrical solenoid valve, which in turn regulates the flow of hydraulic fluid to a hydraulic cylinder involved in the movement of the work tool 20. The response of the machine measured at Step 316 may be the amount of movement of the work tool 20.

After determining the response of the machine to a reference signal such as the PRBS data injected to the plant, post processing steps may be performed in the machine 10 online and in semi-real-time, as illustrated in Box 317 of FIG. 3. The post processing steps may include finding a plant model at Step 318, selecting a plant model online and in real-time at Step 319, and choosing a plant model for use with the control system of the machine 10 at Step 320.

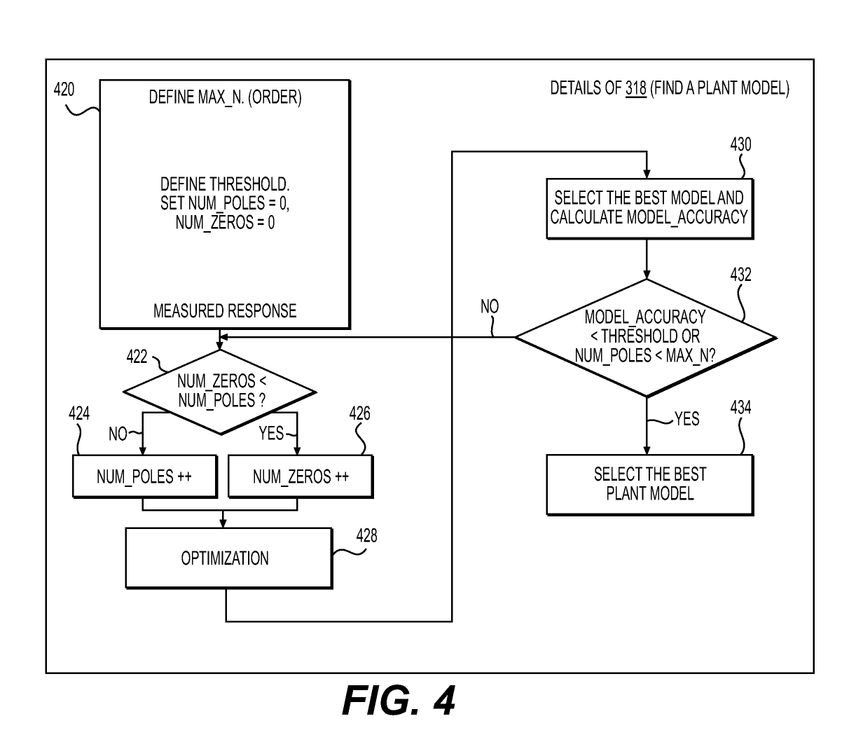

FIG. 4 illustrates the detailed steps performed in finding a plant model at Step 318 of FIG. 3. As shown at Step 420, finding a plant model may include defining a maximum order (MAX_N) for the transfer function that governs the dynamic relationship between one or more inputs and one or more outputs of the plant. The maximum order for the transfer function may be a user-defined parameter or may be estimated by the observed complexity of the relationship between inputs to the machine and desired outputs and a threshold level of error that must be met at Step 432. Step 420 may further set the numbers of poles and zeros for the initial processing.

Step 422 in FIG. 4 checks for the stability of the transfer function by determining whether the number of zeros is less than the number of poles for each iteration of a plant model. If the number of zeros is not less than the number of poles (Step 422: NO) then the plant model is modified to increase the number of poles and reset the number of zeros to zero at Step 424. If the number of zeros is less than the number of poles (Step 422: YES) then the plant model may be modified by increasing the number of zeros at Step 426 as long as the number of zeros is less than the number of poles.

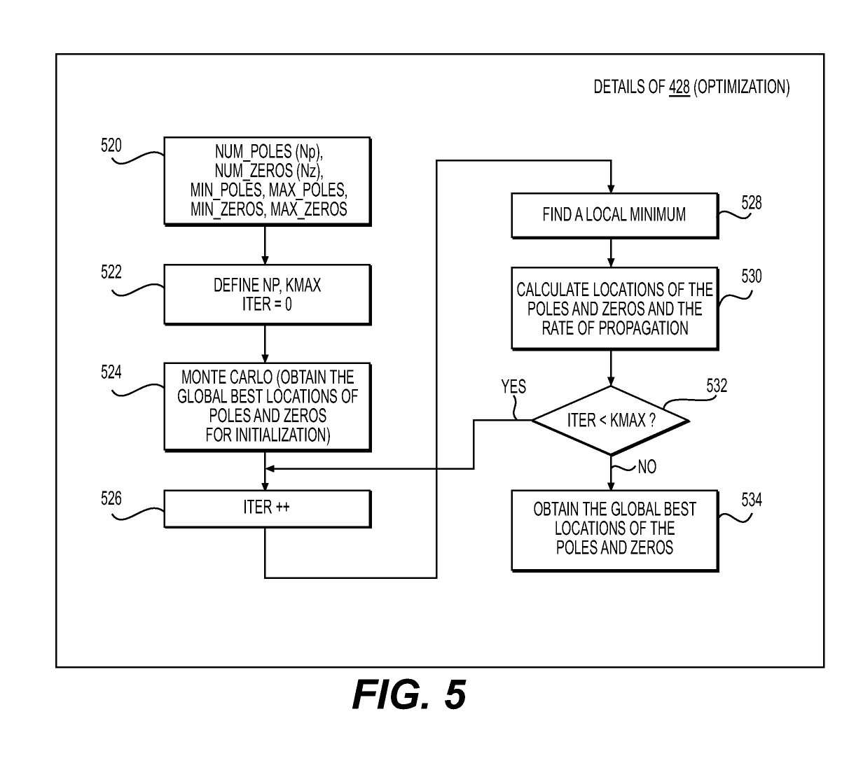

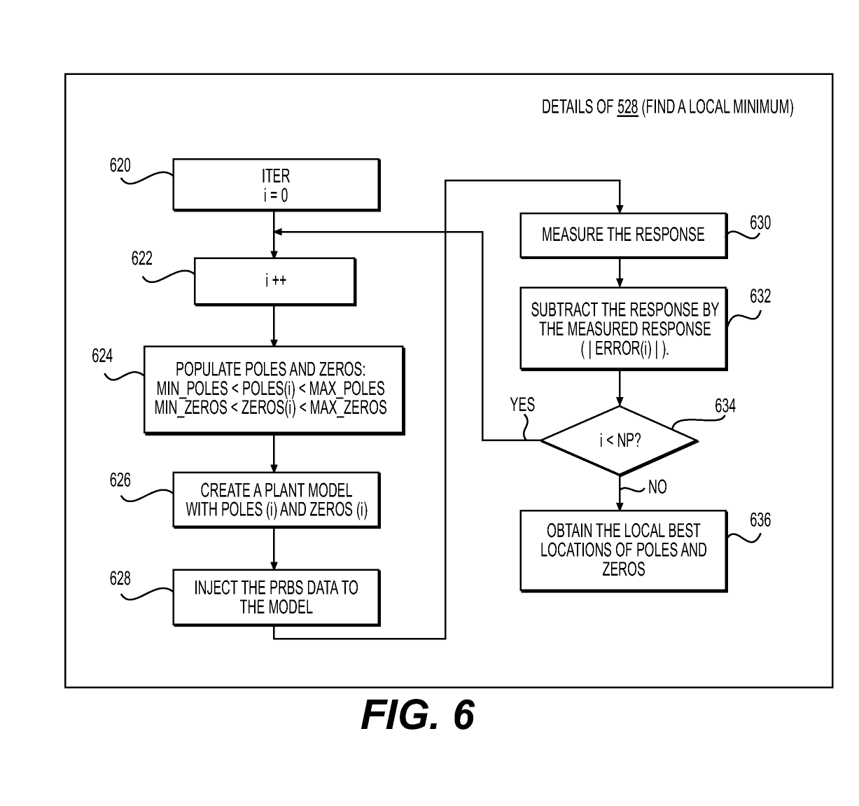

Step 428 in FIG. 4 includes the steps illustrated in FIGS. 5 and 6 for iteratively optimizing the selection of plant models until a plant model with the global best locations of poles and zeros of a transfer function has been determined within the constraints set forth in the process steps illustrated in FIGS. 5 and 6. The global best locations for the poles and zeros of a transfer function represent a transfer function and plant model that will provide a desired accuracy when determining the dynamic relationship between inputs and outputs of the machine. After the optimization process of Step 428, the best plant model is selected for each number of poles and zeros at Step 430 and the accuracy of the selected plant model is calculated. The accuracy of the selected plant model may then be compared to a threshold at Step 432, along with checking the number of poles for the selected plant model. If the model accuracy is less than the predetermined threshold or the number of poles is less than the maximum order MAX_N of the transfer function (Step 432: NO), then the iterative process returns to before Step 422 in FIG. 4 in order to continue to check for the stability of the transfer function, modify the selected plant models as required to adjust the numbers of poles and zeros, and optimize the selection of plant models to arrive at a plant model with the global best locations of poles and zeros for the increased number of poles and zeros. When the model accuracy is determined to be greater than or equal to the predetermined threshold or the number of poles is equal to or greater than the maximum order MAX_N of the transfer function (Step 432: YES), then the process terminates with selection of the best plant model for use by the control system of the machine.

As shown by the detailed steps illustrated in FIG. 5 for the optimization Step 428 of FIG. 4, obtaining the global best locations of the poles and zeros for each plant model corresponding to each number of poles and zeros may start with the given numbers of poles (Np) and zeros (Nz) from FIG. 4, a minimum and maximum value of poles, and a minimum and maximum value of zeros at Step 520. The optimization loop may also include defining the maximum number of iteration (NP) and the maximum number of iterations (KMAX) that will be performed during optimization. At Step 524, various numerical optimization techniques such as the Monte Carlo simulation may be performed in order to obtain the global best locations of the poles and zeros for initialization of the optimization loop. After initialization, advancement to each subsequent iteration at Step 526 may be followed by finding a local minimum error for successive plant models within a subset of plant models for the given number of poles and zeros at Step 528.

The details of finding a local minimum error at Step 528 are illustrated in FIG. 6 and described below. The optimization loop contained within Step 428 of FIG. 4 continues as illustrated in FIG. 5 with calculation of the locations of the poles and zeros and a rate of change (rate of propagation) of the location of poles and zeros at Step 530 in FIG. 5. The optimization loop continues until a determination is made at Step 532 that the number of iterations performed are no longer less than the predetermined maximum number of iterations KMAX (Step 532: NO). At this point the optimization loop is terminated with the global best locations of the poles and zeros which are obtained among the local best locations of the poles and zeros at Step 528 having been obtained at Step 534. If the number of iterations performed is less than the maximum number of iterations KMAX (Step 532: YES), then advancement to the next iteration is continued at Step 526.

The details of finding a local minimum error at Step 528 in FIG. 5 are illustrated in FIG. 6, and include initializing a loop for finding the local best locations of poles and zeros within a subset of plant models having a number of poles and zeros that fall within specified ranges. The iterative process starts at Step 620, with each successive iteration proceeding at Step 622, followed by population of the number of poles and zeros for each successive plant model at Step 624. The location of poles for determination of the plant model with a local minimum error is confined within a range from a minimum to a maximum value of poles, which is the search space for the poles, and the location of zeros is confined within a range from a minimum to a maximum value of zeros which is the search space for the zeros. A plant model is created at Step 626 for each iteration of a new number of poles and zeros. Each successive plant model is then injected with a reference signal such as the PRBS data at Step 628. The response of the latest iteration of a new plant model is then measured at Step 630, and an error value for the latest iteration is determined at Step 632 by subtracting the actual response of the plant (or machine) from the measured response determined using each new iteration of a plant model. The process of finding a local minimum error is continued until the number of iterations has resulted in the number of poles no longer falling within the predetermined range for numbers of poles in the subset of plant models (Step 634: NO). If the number of iterations is still less than the number that results in the number of poles falling outside of the range for the subset of plant models (Step 634: YES) then the process continues. The local best locations of poles and zeros for the allotted number of iterations in the subset of plant models are obtained at Step 636 and returned to the optimization loop at Step 528 illustrated in FIG. 5. The process of converging on the best plant model with the most accurate representation of the dynamic relationship between inputs and outputs for the machine at any particular time during operation of the machine may continue automatically, and may be performed entirely by the electronic controller 250 in real-time, onboard the machine.

Other embodiments, features, aspects, and principles of the disclosed exemplary systems and methods will be apparent to those skilled in the art and may be implemented in various environments and systems.

What is claimed is:

1. A control system for a machine, comprising:
one or more sensors and actuators configured to measure and control operational characteristics of the machine; and
an electronic controller mounted onboard the machine, the electronic controller being configured to receive a sensor signal indicative of an operational parameter of the machine, and to output a control signal to an actuator to control an operational characteristic of the machine, the electronic controller including:
a poles-zeros identification module configured for determining poles of one or more transfer functions as roots of the denominator of the one or more transfer functions and determining zeros of the one or more transfer functions as roots of the numerator of the one or more transfer functions;
an onboard system identification module configured for online, real-time identification of the one or more transfer functions that govern a dynamic relationship between one or more inputs and one or more outputs of at least one plant model, wherein the at least one plant model is representative of behaviors of the machine and simulates a dynamic influence of the operational parameter on a desired output of the machine, the onboard system identification module being further configured to define an order of a numerator of the one or more transfer functions and an order of a denominator of the one or more transfer functions based on a complexity of the dynamic relationship between the one or more inputs and the one or more outputs;
a testing module configured for generating a reference signal and supplying the reference signal as an input to the one or more transfer functions; and
a comparator configured for determining an accuracy of the at least one plant model by determining an error between a measured response of the machine to the reference signal and a predicted response obtained from the one or more transfer functions with the poles and zeros.

2. The control system of claim 1, further including:
a user interface configured to present to a machine operator in real-time at least one plant model identified by the onboard system identification module and an associated accuracy of the at least one plant model as determined by the comparator, and the user interface further configured to receive a selection by the machine operator of at least one of a preferred plant model or a request for identification of a plant model with an improved accuracy.

3. The control system of claim 1, wherein the one or more sensors and actuators are configured to provide input and output variables corresponding to at least one of position and movement of a work implement of the machine.

4. The control system of claim 1, wherein the electronic controller is further configured to:
determine locations of the poles and zeros for each of a plurality of transfer functions using the poles-zeros identification module; and
iteratively identify the plurality of transfer functions governing the dynamic relationships between multiple inputs and multiple outputs of a succession of plants.

5. The control system of claim 4, wherein the electronic controller is further configured to:
determine an error for each of the plurality of transfer functions using the comparator;
select a transfer function of the plurality of transfer functions that results in an error that is less than an error of a previous iteration of a transfer function; and
continue to identify iterations of transfer functions until a selected transfer function no longer results in an error that is less than an error of a previous iteration of a transfer function.

6. The control system of claim 4, wherein the electronic controller is further configured to:
determine a rise time for the control system that is a function of the time needed by the control system to reach a desired output value after a change in an input to the control system; and
determine a DC gain for the control system.

7. The control system of claim 4, wherein the electronic controller is further configured to:
determine whether an identified transfer function is representative of a stable system by determining whether the number of zeros for the identified transfer function is less than or equal to the number of poles; and
define ranges for locations of zeros and poles, a DC gain, and a maximum number of iterations to be performed in selecting the locations of poles and zeros for each number of poles and zeros that generate a transfer function with an error that is less than an error of any previous iteration of a transfer function.

8. The control system of claim 7, wherein the electronic controller is further configured to select a transfer function with an error that is less than an error of any previous iteration of a transfer function by performing an optimization technique to determine locations of the poles and zeros of one of the plurality of identified transfer functions that result in the smallest error of all of the identified transfer functions.

9. The control system of claim 8, wherein the electronic controller is further configured to:
define a maximum number of iterations for identifying a subset of the plurality of transfer functions, with each of the transfer functions in the subset having a number of poles within a predefined range and a number of zeros within a predefined range;
generate a pseudo-random-binary-sequence (PRBS) signal;
supply the PRBS signal to each of the transfer functions in the subset of the plurality of transfer functions;
determine a predicted response of the machine to the PRBS signal using locations of the poles and the zeros for each transfer function;
calculate an error for each transfer function by subtracting the predicted response from an actual response of the machine to the PRBS signal; and
identify a transfer function in the subset with the smallest error based on the locations of the poles and the zeros for the transfer function.

10. A method of controlling a machine, the method comprising:
measuring an operational parameter characterizing operation of the machine using a sensor;
receiving at an onboard electronic controller a sensor signal from the sensor indicative of the operational parameter of the machine;
outputting a control signal from the onboard electronic controller to an actuator to control an operational characteristic of the machine;
determining poles of one or more transfer functions as roots of the denominator of the one or more transfer functions and determining zeros of the one or more transfer functions as roots of the numerator of the one or more transfer functions;
identifying in real-time the one or more transfer functions using a system identification module that is included in the onboard electronic controller, wherein the one or more transfer functions govern a dynamic relationship between one or more inputs and one or more outputs of at least one plant, and wherein the at least one plant model is representative of behaviors of the machine and simulates a dynamic influence of the operational parameter on a desired output of the machine;
defining an order of the one or more transfer functions based on a complexity of the dynamic relationship between the one or more inputs and the one or more outputs;
generating a reference signal and supplying the reference signal as an input to the one or more transfer functions; and
determining an accuracy of the at least one plant model by determining an error between a measured response of the machine to the reference signal and a predicted response calculated from locations of the poles and zeros of the one or more transfer functions.

11. The method of claim 10, further including:
presenting to a machine operator in real time on a user interface the at least one plant model and an associated accuracy of the at least one plant model; and
receiving on the user interface a selection by the machine operator of at least one of a preferred plant model or a request for identification of a plant model with an improved accuracy.

12. The method of claim 10, further including providing inputs and outputs of the at least one plant model corresponding to at least one of a position and movement of a work implement of the machine.

13. The method of claim 10, further including:
determining locations of the poles and zeros for each of a plurality of transfer functions; and
iteratively identifying the plurality of transfer functions governing the dynamic relationships between multiple inputs and multiple outputs of a succession of plant models.

14. The method of claim 13, further including:
determining an error for each of the plurality of transfer functions;
selecting a transfer function of the plurality of transfer functions that results in an error that is less than an error of a previous iteration of a transfer function; and
continuing to identify iterations of transfer functions until a selected transfer function no longer results in an error that is less than an error of a previous iteration of a transfer function.

15. The method of claim 13, further including:
determining a rise time for the control system that is a function of the time needed by the control system to reach a desired output value after a change in an input to the control system; and
determining a DC gain for the control system.

16. The method of claim 13, further including:
determining whether an identified transfer function is representative of a stable system by determining whether the number of zeros for the identified transfer function is less than or equal to the number of poles; and
defining ranges for locations of zeros and poles, a DC gain, and a maximum number of iterations to be performed in selecting the locations of poles and zeros for each number of poles and zeros that generate a transfer function with an error that is less than an error of any previous iteration of a transfer function.

17. The method of claim 16, further including selecting a transfer function with an error that is less than an error of any previous iteration of a transfer function by performing a Monte Carlo simulation to determine locations of the poles and zeros of one of the plurality of identified transfer functions that result in the smallest error of all of the identified transfer functions.

18. The method of claim 17, further including:
defining a maximum number of iterations for identifying a subset of the plurality of transfer functions, with each of the transfer functions in the subset having a number of poles within a predefined range and a number of zeros within a predefined range;
generating a pseudo-random-binary-sequence (PRBS) signal;
supplying the PRBS signal to each of the transfer functions in the subset of the plurality of transfer functions;
determining a predicted response of the machine to the PRBS signal using locations of the poles and the zeros for each transfer function;
calculating an error for each transfer function by subtracting the predicted response from an actual response of the machine to the PRBS signal; and
identifying a transfer function in the subset with the smallest error based on the locations of the poles and the zeros for the transfer function.

19. A computer-readable medium for use in a machine control system, the computer-readable medium comprising computer-executable instructions for performing a method with at least one processor of an onboard electronic controller of a machine, wherein the method comprises:
receiving at the onboard electronic controller a sensor signal from a sensor indicative of an operational parameter of the machine;
outputting a control signal from the onboard electronic controller to an actuator to control an operational characteristic of the machine;
determining poles of one or more transfer functions as roots of the denominator of the factored form of the one or more transfer functions and zeros of the one or more transfer functions as roots of the numerator of the factored form of the one or more transfer functions;
identifying in real-time the one or more transfer functions using a system identification module that is included in the onboard electronic controller, wherein the one or more transfer functions govern a dynamic relationship between one or more inputs and one or more outputs of at least one plant model, and wherein the at least one plant model is representative of behaviors of the machine and simulates a dynamic influence of the operational parameter on a desired output of the machine;
defining an order of the one or more transfer functions based on a complexity of the dynamic relationship between the one or more inputs and the one or more outputs;
generating a reference signal and supplying the reference signal as an input to the one or more transfer functions; and
determining an accuracy of the at least one plant model by determining an error between a measured response of the machine to the reference signal and a predicted response calculated from locations of the poles and zeros of the one or more transfer functions.

20. The computer-readable medium of claim 19, wherein the method further includes:
determining locations of poles and zeros for each of a plurality of transfer functions;
iteratively identifying a plurality of transfer functions governing the dynamic relationships between multiple inputs and multiple outputs of a succession of plant models;
determining an error for each of the plurality of transfer functions;
selecting a transfer function of the plurality of transfer functions that results in an error that is less than an error of a previous iteration of a transfer function; and
continuing to identify iterations of transfer functions until a selected transfer function no longer results in an error that is less than an error of a previous iteration of a transfer function.
